(19) United States
(12) Patent Application Publication
(10) Pub. No.: US 2014/0106199 A1
(43) Pub. Date: Apr. 17, 2014

(54) ENERGY STORAGE APPARATUS HAVING A TEMPERATURE CONTROL DEVICE

(71) Applicants: Jens Meintschel, Bernsdorf (DE); Tim Schaefer, Harztor (DE)

(72) Inventors: Jens Meintschel, Bernsdorf (DE); Tim Schaefer, Harztor (DE)

(73) Assignee: LI-TEC BATTERY GMBH, Kamenz (DE)

(21) Appl. No.: 14/009,948

(22) PCT Filed: Mar. 28, 2012
(86) PCT No.: PCT/EP2012/001368

§ 371 Date: Dec. 27, 2013

(30) Foreign Application Priority Data
Apr. 4, 2011 (DE) 10 2011 016 048.5

(51) Int. Cl. H01M 6/50

(52) U.S. Cl. CPC H01M 6/5038
USPC 429/120

(57) ABSTRACT

An energy storage device (1) has at least one energy storage cell (2), preferably a number of energy storage cells (2), and a temperature controlling means, which is designed for controlling the temperature of the energy storage cell (2) or an assembly formed by the energy storage cells (2), and at least one clamping element (8, 20), which is designed as a functional component part of the temperature controlling means and is designed for carrying a heat transfer medium.

### DESCRIPTION

The entire content of the DE102011016048 priority application is fully incorporated as an integral part of the present application by reference herein.

The present invention relates to an energy storage apparatus having at least one energy storage cell and a temperature control device, in particular an energy storage apparatus having a plurality of energy storage cells and a temperature control device.

Electrochemical energy stores, also referred to as electrochemical or galvanic cells in the following, are frequently manufactured in the form of flat stackable units, from which batteries for various applications can be produced by combining a plurality of such cells.

The cells must often be cooled in order to dissipate the thermal losses which occur. To this end, it is known to make use of indirect cooling via a coolant circuit or direct cooling by means of pre-cooled air directed between the cells. In the case of cooling by means of the coolant circuit, a metallic cooling plate through which coolant flows can be disposed on the battery's cell block, often underneath the cells. The heat loss is directed from the cells to the cooling plate for example either via separate heat-conducting elements, e.g. heat-conducting rods or heat conduction plates, or via correspondingly thickened cell housing walls. Cell housings of cells are frequently metallic and subject to electrical voltage. To prevent short circuits, the cooling plate is then separated from the cell housings by electrical insulation, for example a thermally conductive foil, a molding, a casting compound or a coating or film applied to the cooling plate. The coolant circuit can also be used to warm up the battery, e.g. from a cold start.

The present invention is based on the object of providing an improved energy storage apparatus.

This object is accomplished by an energy storage apparatus in accordance with claim 1. The subclaims relate to advantageous further developments of the invention.

With an energy storage apparatus having at least one energy storage cell, preferably a plurality of energy storage cells, and a temperature control device which is designed to regulate the temperature of the energy storage cell or an assembly formed by the energy storage cells, and at least one clamping element which is designed to contribute to spatially fixing the energy storage cells in the energy storage apparatus via tensioning force, said object is accomplished by the clamping element being designed as a functional component of the temperature control device and by the clamping element being designed to conduct a heat transfer medium.

In the terms of the invention, an energy storage apparatus is to be understood as a device which is also able to absorb, store and in turn release particularly electrical energy, if necessary using electrochemical processes. In the terms of the invention, a storage cell is to be understood as a self-contained functional unit of the energy storage apparatus which itself is also able to absorb, store and then in turn release particularly electrical energy, if necessary using electrochemical processes. A storage cell can for example, but not solely, be a galvanic primary or secondary cell (in the context of the present application, primary or secondary cells are indiscriminately referred to as battery cells and an energy storage apparatus composed therefrom as a battery), a fuel cell, a high-performance capacitor such as for instance a supercap or the like, or a different type of energy storage cell. Particularly, a storage cell designed as a battery cell comprises for example an active section or active part in which electrochemical conversion and storing processes occur, a casing to encapsulate the active part from the environment and at least two current conductors which serve as the electrical terminals of the storage cell. The active part comprises for example an electrode array configured preferably as an electrode stack or a coil with current collector films, active layers and separator layers. The active and separator layers can be at least partially provided as separate pre-cut films or as coatings on the current collector films. The current conductors are electrically connected to or formed by the current collector films.

An energy storage cell in the present context is to be in particular understood as an electrochemical cell which stores energy in chemical form, dispenses it to a load in electrical form, and can preferably also absorb it in electrical form from a charging device. Galvanic cells and fuel cells are important examples of such electrochemical energy stores.

A flat electrochemical cell in the present context is to be understood as an electrochemical cell, its outer form characterized by two substantially parallel surfaces, their perpendicular distance from one another being shorter than the mean length of the cell measured parallel to said surfaces. The electrochemically active components of the cell, frequently encased in packing or a cell housing, are arranged between said surfaces. Such cells are frequently encased in a multilayer packaging film having a sealed seam at the edges of the cell packing formed by a permanent bonding or sealing of the packaging film in the area of the sealed seam. Such cells are also frequently called pouch cells or coffee bag cells.

The clamping element contributing to spatially fixing the energy storage cells in the energy storage apparatus can refer in the sense of the invention to both partly contributing to the spatial fixation as well as a one hundred percent contribution, particularly contributing exclusively to the spatial fixation.

The energy storage cells can furthermore have an expandable multilayer film as the outer casing for absorbing resultant gases.

A storage cell can be also a cell which absorbs and/or releases energy not as electrical energy, but rather as thermal, potential, kinetic or another type of energy or a cell which absorbs one type of energy and releases it in turn as another type of energy, whereby the energy can be stored as yet another type.

In the terms of the invention, a clamping is to be understood as a retaining in a pre-determined position, particularly a relative position to one another, by tensioning forces. Elastic and frictional forces can, but not restrictively, also be used in clamping. The clamping does not incidentally exclude a form-locking position securing; it can, albeit it is not imperative, to be limited to hindering components from coming apart.

Temperature regulation in the sense of the inventive refers to a removal or supply, particularly a removal, of heat. It can be realized as passive cooling, for instance by thermal radiation at heat radiating surfaces, as active cooling, for instance by forced convection at heat transfer surfaces, or by heat transfer with a particularly circulating heat transfer medium such as for instance water, oil or the like in a heat exchanger. A control and/or regulation can thereby be provided in order to maintain a predefined allowable temperature range.

When the clamping device is designed as a functional component of the temperature control device and for conducting a heat transfer medium, the clamping device can also fulfill functions associated with controlling the temperature of the storage cells or the cell assembly respectively. These functions can for example, but not exclusively, include heat transfer from and to the storage cells, thermal radiation at heat radiating surfaces, heat transfer from and to a heat transfer medium, thermal conduction from and to a heat source or a heat sink and/or the like.

It has proven advantageous for the clamping element to be directly connected to a heat transfer medium circuit.

The clamping device preferably comprises at least one tie rod configured as a hollow bar. One advantage of this design is that the heat transfer medium can be directed through the tie rod.

To be understood as a tie rod in the terms of the invention is an elongated bar particularly projecting the entire length of the cell stack which in particular braces the cell block by means of pressure elements such as plates or flanges which press against the respectively outer storage cells in a stacking direction of the storage cells. A plurality of tie rods are normally provided, for instance four, six, eight or more. Such tie rods exhibit for example a head on one end and a thread on the other end or threads on both ends in order to enable reliable bracing upon tightening via screwing in or bolting with nuts. Making use of tie rods with the appropriate design to the storage cells also has the advantage that storage cells can be threaded onto the tie rod prior to the clamping in relatively simple fashion, which can also simplify assembly. Tie rods can for example extend through corresponding recesses in frame elements of flat-cell frames and absorb heat from same.

The tie rod configured as a hollow bar can moreover lead to a heat exchanger.

It is particularly preferential for the clamping element to comprise at least one pair of tie rods configured as hollow bars closed into a circuit by means of a bridge. One advantage of this design is being able to form a particularly simple heat transfer medium circuit.

It has proven advantageous for the tie rod configured as a hollow bar to comprise two longitudinal bores designed as a forward flow and a return flow channel.

Alternatively or additionally, the clamping element can comprise at least one tension band. Preferably, the tension band exhibits two longitudinal bores designed as a forward flow and a return flow channel. It is particularly preferential for the clamping device to comprise at least one pair of tension bands closed by a bridge into a circuit.

The tension band can be of intrinsically resilient design, at least in sections, particularly formed as a wave spring, wherein preferably a plurality of tension bands are provided of which at least one tension band covers at least one other tension band. In the terms of the invention, a tension band is to be understood as an elongated, particularly flat, strap-like component which can also be used to brace an arrangement of storage cells against each other, particularly in a wrap-around bracing. A locking mechanism, a clamping mechanism or the like can thereby be provided to enable a tensioned assembly. An intrinsically resilient design can also achieve a uniform tensioning force being exerted on the cell block. An elastic elongation of the tension band can be configured such that the tension band can be oversized relative the cell block and stretched over same during tensioned assembly, whereby when the pretensioning then relaxes, the tension band tightly girdles the cell block. To this end, sections of the tension band can for example be of wave spring design. It is particularly preferential for the wave spring-formed sections to exhibit flat sections which bear against the heat exchange surfaces of storage cells, heat conducting elements, etc. under tension.

The clamping element being connected to a heat exchanger has proven advantageous.

Furthermore, the clamping element can be at least partially formed from a heat conducting material. Alternatively and/or additionally, the clamping element can at least partially comprise a heat conducting layer.

In the terms of the invention, a material is to be understood as heat conducting when it exhibits a thermal conductivity which allows its use as a heat conductor in the technical sense. An acceptable lower limit can be in the range of approximately 10 to 20 W m⁻¹ K⁻¹ which corresponds to the thermal conductivity of high-alloy steel and several plastics provided with good heat conducting fillers (preferably fiber-reinforced). Selecting a thermal conductivity range of at least 40 to 50 W m⁻¹ K⁻¹ is preferable.

A thermal conductivity of at least 100 or a few 100 W m⁻¹ K⁻¹ is particularly preferable. For example, albeit not restrictively, spring steel can use silicon, aluminum, copper, silver or particularly carbon nanotubes. The use of these or other special materials is to be weighed against the cost, processability and other technical criteria. In this context, the design of a heat conducting material in the terms of the invention is to be understood as the clamping device or an element of the clamping device either consisting substantially of said material or else, for instance for reasons of rigidity, electrical insulation, thermal stability or other properties or purposes, only a core, a coating or a layer, a casing or the like, can comprise such material. The desired properties can thus be established by the appropriate material combination. The same materials as noted above, or also other good heat conductors such as ceramic or diamond, for instance, would also make conceivable fillers for heat conducting plastics.

It is further preferential for the energy storage apparatus to be designed such that at least sections of the clamping device bear preferably flatly against the heat exchange surfaces of the storage cells. In the terms of the invention, a heat exchange surface of a storage cell can be understood as a surface of the storage cell which can emit the heat generated in the interior of the storage cell and which can also absorb heat as needed to release it into the interior of the storage cell. It is advantageous for the structural element which encompasses the heat exchange surface to be designed to transfer heat generated in an active area of the cell to the heat exchange surface. This construction ensures good thermal coupling. The thermal coupling can be produced as needed by means of a heat conducting element which can also fulfill the electrical insulation or other similar functions.

It is particularly preferential for the energy storage apparatus to be designed so that the storage cells have a prismatic, particularly flat, form and heat exchange surfaces are provided on at least one of the peripheral, particularly narrow, sides of the storage cells. In the sense of the invention, a flat prismatic form refers to a form having a considerably smaller expansion in one spatial direction which is also defined as the thickness direction than is the case in other spatial directions and thus two flat sides of comparatively larger surface area are clearly distinguished from a narrow edge, particularly at least four peripheral or narrow sides. Flat, prismatic storage cells can stack into a cell assembly, particularly a compact block, particularly well, they utilize space well, and their contacting can be realized in many different ways, for instance via the flat sides, via the narrow sides, via projecting conductor strips (also called current conductors) or the like. In stacked prismatic cells, the peripheral sides are on the outside so that they lend themselves to being heat exchange surfaces. The invention is also applicable to not markedly flat but rather, for example, albeit not restrictively, cubic storage cells, just as it is to not prismatic but rather, for example, albeit not restrictively, cylindrical storage cells.

Preferably, the energy storage apparatus is designed such that heat conducting elements formed from a thermally conductive material and which at least sectionally, preferably flatly, bear on the heat exchange surfaces of the storage cells are provided, wherein the clamping device bears at least on the free surfaces of the heat conducting elements. In the terms of the invention, a heat conducting element is to be understood as a structural element which is also able to conduct heat from and to storage cells, particularly from and to a space between storage cells inside the energy storage apparatus, from and to externally of the space between the storage cells. A heat conducting element can for example, albeit not restrictively, be a sheet or a molding made from a heat conducting material arranged between the storage cells. Here, a free surface of a heat conducting element in the sense of the invention refers to a surface which is accessible externally of the cell assembly of storage cells, e.g. projecting at their free edges and for example, albeit not mandatory, bent at a right angle there so as to bear on the edges of the storage cells. It is preferential here as well for the storage cells to exhibit a prismatic, particularly flat, form; the heat exchange surfaces can then be provided preferably on the flat sides of the storage cells and the free surfaces of the heat conducting elements can be provided preferably in the area of the peripheral sides, particularly the narrow sides, of the storage cells. When the flat sides of the storage cells are configured as electrical terminals of the storage cells, the heat conducting elements can also be designed with electrically conductive materials and additionally function as electrical contact elements between adjacent storage cells or between one storage cell and a terminal connection device of the energy storage apparatus. A heat conducting element can alternatively have an electrically insulating property exactly when electrical contact needs to be prevented.

In one further preferred embodiment, the clamping device comprises retaining elements and tensioning elements, whereby the retaining elements are disposed alternatingly with the storage cells so as to hold the storage cells between them, and whereby the tensioning elements brace the retaining elements to the storage cells, wherein at least sections of the retaining elements are thermally coupled to the heat exchange surfaces of the storage cells, and wherein at least sections of the tensioning elements bear on the heat exchange surfaces of the retaining elements. It is thereby advantageous for the retaining elements to be configured with a heat conducting material at least between the contact surfaces with the storage cells and the contact surfaces with the tensioning elements. So doing also provides a reliable tensioning of the retaining elements and the storage cells into a battery block. Heat exchange surfaces of the retaining elements can be outer surfaces, particularly edge surfaces, of the retaining elements, for example, but not solely, when tension bands are provided as tensioning elements. Tensioning elements such as for example, but not solely, tie rods can also be guided through passages, for instance bores, in the retaining elements; in this case, heat exchange surfaces of the retaining elements can be formed by the inner surfaces of the passages. Storage cell heat exchange surfaces can be provided by flat or edge sides of the storage cells, by current conductors or at passage areas of current conductors through a housing of the storage cells.

It is further preferential for the energy storage apparatus to be designed such that at least sections of the tensioning device are thermally coupled, particularly in flat contact, to sections of a heat exchange device, wherein the heat exchange device is preferably connected to a heat transfer medium circuit and wherein the heat transfer medium circuit can preferably be controlled/regulated. So doing enables the tensioning device to convey the heat absorbed from the storage cells to the heat exchange device and release it there to a heat transfer medium such as for example, but not exclusively, water or oil. The heated heat transfer medium can circulate through the heat transfer medium circuit and give off the absorbed heat again at other points, for instance to an air cooler or the like.

It is particularly preferential for at least sections of the heat exchange device to bear on heat exchange surfaces of the storage cells, wherein the storage cells exhibit a flat primastic form and heat exchange surfaces are provided on at least two, preferably oppositely positioned, narrow sides of the storage cells. Thus, the storage cells can on the one hand release heat to the heat exchange device through direct contact and, on the other hand, release heat to points on the tensioning device which are not in contact with the heat exchange device. The tensioning device thereby preferably braces the cells both to each other as well as also to the heat exchange device.

The features of the described and further embodiments of the invention can advantageously be combined with one another, thereby putting further embodiments of the invention which are unable to be conclusively and completely described herein at the disposal of one skilled in the art.

The following will draw on preferential embodiments as well as the figures in describing the invention in greater detail. Shown are:

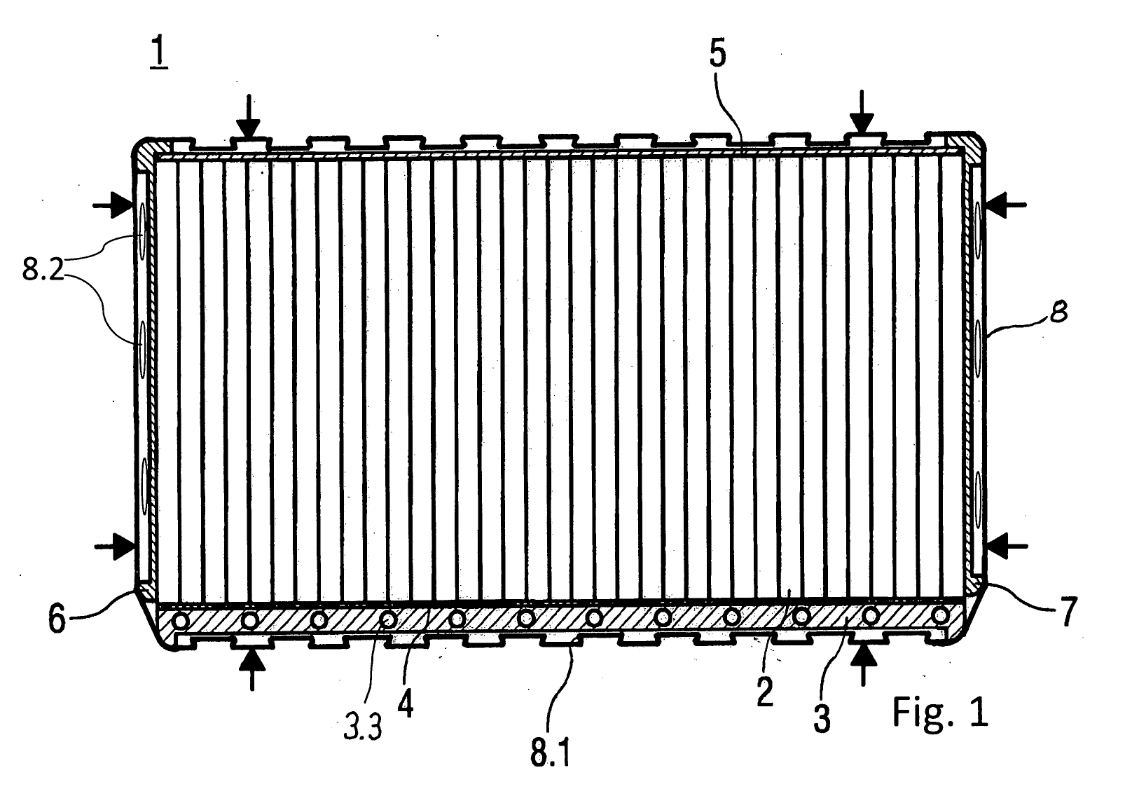

FIG. 1 a cross-sectional representation of a battery in accordance with a first embodiment,

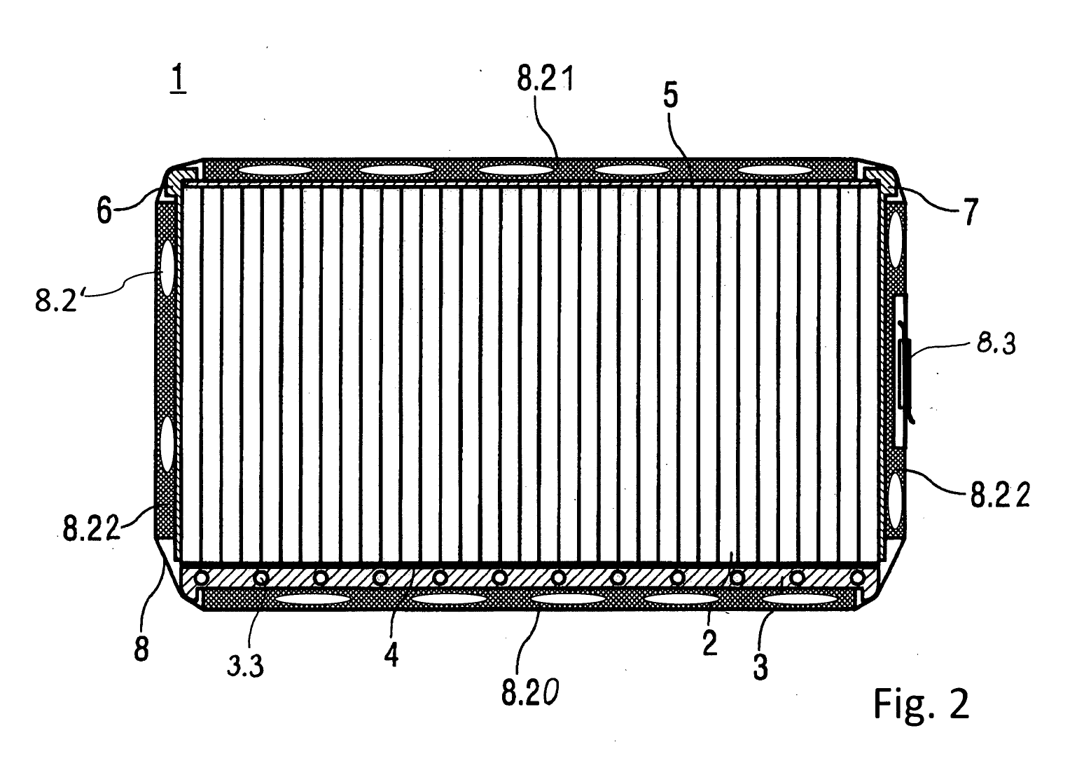

FIG. 2 a cross-sectional representation of a battery in accordance with a second embodiment,

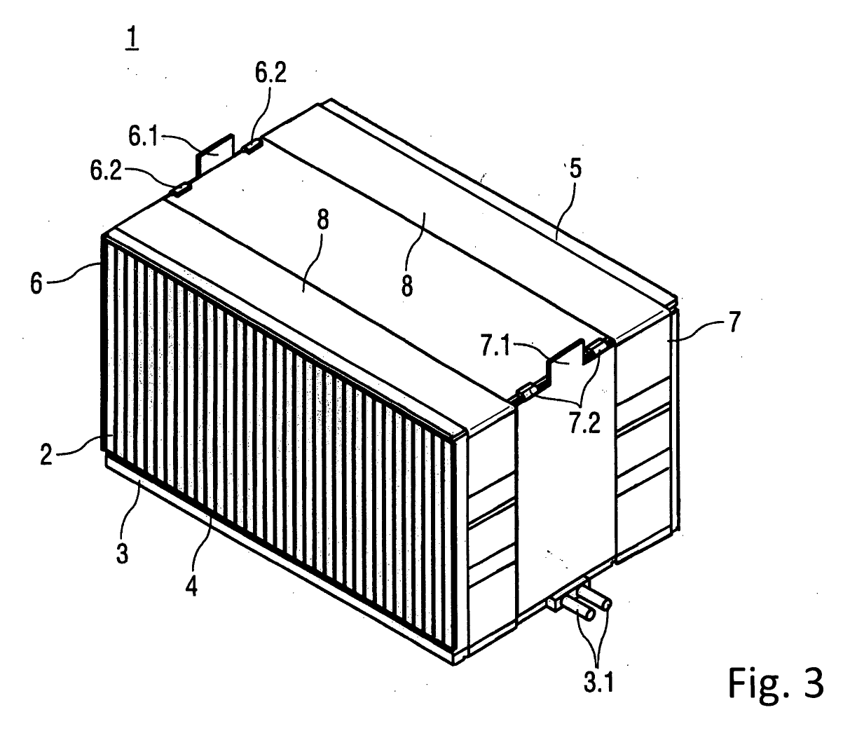

FIG. 3 a perspective depiction of the battery according to the second embodiment,

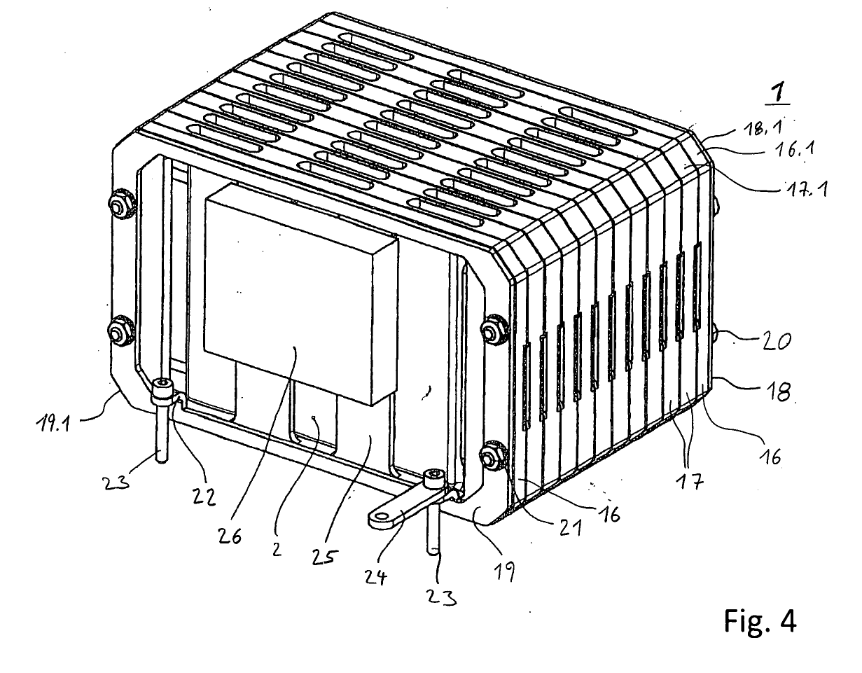

FIG. 4 a perspective depiction of the battery according to a third embodiment, and

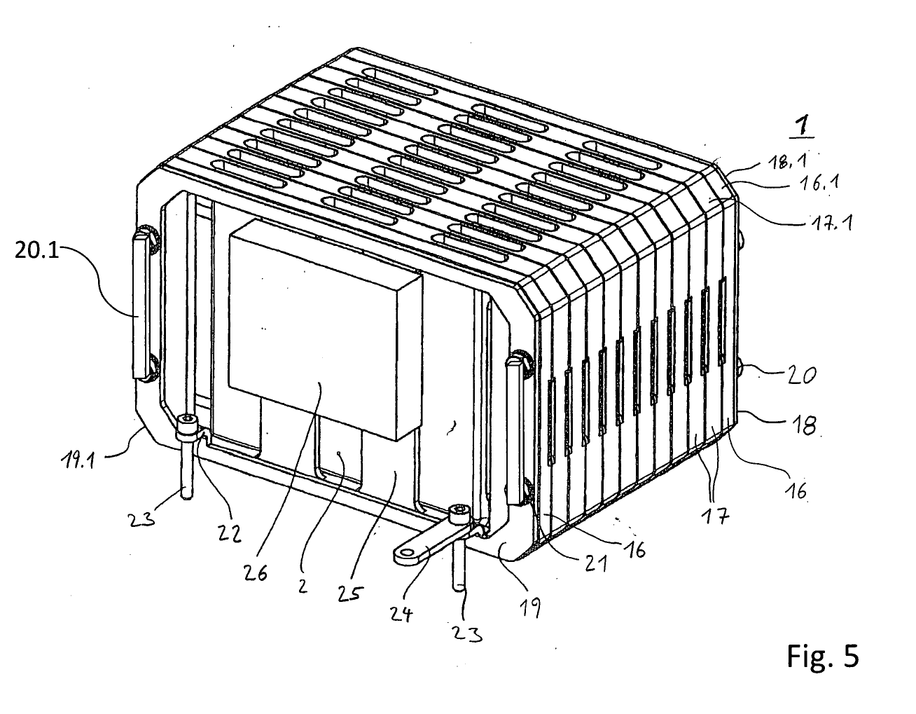

FIG. 5 a perspective depiction of the battery according to a fourth embodiment.

FIG. 1 illustrates a battery 1 comprising a plurality of galvanic cells 2 formed into a cell assembly in a schematic representation of a first embodiment of the present invention. FIG. 1 depicts the cells 2 unsectioned.

The galvanic cells 2 are secondary cells (accumulator cells) comprising active areas containing lithium. The structure of such galvanic cells, known as lithium ion cells or the like, is generally known. In the context of the present application, the galvanic cells 2 will be called cells 2 for simplicity's sake. In the present embodiment, the cells 2 are configured as so-called flat-frame cells having a narrow, substantially rectangular cell housing. The cells 2 are arranged one behind the other in plane-parallel fashion and, depending on the application, can be electrically interconnected in parallel and/or in series.

A cooling plate 3 can be arranged beneath the cells 2 to control the temperature of the cells 2. The cooling plate 3 comprises a cooling channel 3.3 in its interior, sectioned multiple times in the figure, through which a coolant can flow. A heat conducting film 4 of electrically insulating material is arranged between the cooling plate 3 and the bottom area of the cells 2 which electrically insulates the cooling plate 3 from the cells 2. A pressure plate 5 of electrically insulating material having good heat conducting properties such as for instance reinforced plastic with thermally conductive dopings is arranged above the cells 2. The pressure plate 5 can alternatively be made from a metal such as for instance steel, aluminum or the like, whereby an electrically insulating coating or an electrically insulating intermediate layer similar to the heat conducting film 4 is then provided in the areas bearing on the upper narrow sides of the cells 2.

A front terminal plate 6 is disposed at a front end of the cell assembly and a rear terminal plate 7 is disposed at a rear end of the cell assembly. The terminal plates 6 and 7 in each case form a terminal of the battery 1 and each comprise a tab-like elongation 6.1, 7.1 projecting beyond the pressure plate 5 which in each case form a terminal contact of the battery 1.

The terminal plates 6 and 7 respectively further comprise two fixing lugs 6.2, 7.2 angled parallel to the pressure plate 5 of the respective terminal plate 6, 7 and bearing on said pressure plate 5. The pressure plate 5, the cells 2 and the cooling plate 3 are pressed together by means of two clamping elements 8, each guided around the pressure plate 5, the terminal plates 6, 7 and the cooling plate 3. In the present embodiment, the clamping elements 8 are configured as inherently elastic tension bands 8 having tension band interstices 8.2, whereby the intrinsic elasticity is substantially set by spring zones 8.1. The spring zones 8.1 are realized by a wave-like shape to the tension bands 8. The spring zones 8.1 are thereby preferably formed at the point where the tension bands 8 do not extend over the edges of the terminal plates 6, 7 or the cooling plate 3, in particular on the upper and lower side of the battery 1. Their wave shape at least partially exhibits at least substantially flat sections around a large contact surface at least in the area of the wave troughs bearing on the cooling plate 3 and the pressure plate 5. The forces are introduced into the cell block 1 in an axial direction via the front terminal plate 6 and the rear terminal plate 7. In the direction perpendicular thereto, the force is introduced below via the cooling plate 3 and above via the pressure plate 5. To prevent a short circuit, the terminal plates 6, 7 are further provided with an electrically insulating coating or an electrically insulating intermediate layer similar to heat conducting film 4 where the tension bands 8 overlie. The tension bands can moreover also exhibit elastic sections in the area of the terminal plates 6, 7.

The tension bands 8 with tension band interstices 8.2 for conducting the heat transfer medium are made from a good heat conductor such as e.g. spring steel and have heat conducting contact with the pressure plate 5 and the cooling plate 3 in the area of the spring zone 8.1 wave troughs. An electrically insulating coating of the tension bands 8 or an insulating intermediate layer is provided at least in the area of the terminal plates. In one embodiment variant, the tension bands can be made from a non-conductive material, for instance a thermally conductive plastic, preferably reinforced with glass fiber, Kevlar or metal, and a thermally conductive filler material. In such a case, an additional insulation may under certain circumstances not be necessary.

The heat conducting properties of the tension band 8 with the tension band interstices 8.2, the pressure plate 5 and the thermally conductive contact of the pressure plate 5 to the upper side of the cells and the tension band 8 can result in thermal equilibrium between the cells 2 also occurring in the upper area of the battery on the one hand as well as a heat transfer from the upper side to the cooling plate 3 located on the lower side.

FIG. 2 illustrates a further embodiment of the present invention in a depiction corresponding to FIG. 1 in which heat conducting elements 8.20, 8.21, 8.22 are provided between a tension band 8 with tension band interstices 8.2 skirting a cell block and the cell block.

In accordance with the FIG. 2 representation, a lower heat conducting element 8.20 can be provided between the tension band 8 and the cooling plate 3, an upper heat conducting element 8.21 between the tension band 8 and the pressure plate 5, and face side heat conducting elements 8.22 between the tension band 8 and the terminal plates 6, 7. Rigid metal blocks such as e.g. aluminum blocks can be used as the heat conducting elements 8.20, 8.21, 8.22. The tension band runs around the cell pack and ensures a constant contact pressure in the axial direction as well as in the direction of the vertical axis. The tension band 8 is sealed by means of a crimp seal 8.3; this ensures reliable clamping of the battery 1.

In one embodiment variant, the heat conducting elements 8.20, 8.21, 8.22 can have elastic properties and be configured for example as corrugated metal springs, pads filled with metal cuttings, metal-doped foam mats, pads or mats comprising a heat conducting gel or interstices 8.2′ for conducting a heat transfer medium or the like.

Differing from the embodiment depicted in FIG. 1, the tension band 8 is of straight design; i.e. without elastic corrugation, and fully bears on the heat conducting elements 8.20, 8.21, 8.22.

FIG. 3 shows a schematic depiction of a further embodiment. The optional cooling plate 3 comprises a cooling channel 3.3 within its interior through which a coolant can flow as well as two coolant connections 3.1 for the supply and discharge of the coolant. The cooling plate 3 can be connected via coolant connections 3.1 to a not-shown coolant circuit by means of which the waste heat absorbed by the coolant can be dissipated from the battery 1.

In this embodiment variant, the clamping device is realized by two metallic tension bands 8 with tension band interstices 8.2 which can be provided with an electrically insulating yet heat conducting layer. The tension bands 8 exhibit a clamping range 8.4 which is designed in the depicted embodiment variant as a wave-like expansion area. A crimping process can also be used instead of an expansion area to tension the tension bands and firmly bind the ends to each other. In a further alternative, toggle closures, screw couplings or a similar type of tightener can be provided. Although a clamping range 8.4 can only be seen on the side of the rear terminal plate 7 in the figure, such clamping ranges can also be provided on the side of the front terminal plate 6.

The tension bands 8 run in slots 5.1 across the pressure plate 5, in slots 7.3 across the rear terminal plate 7, in slots 3.2 across the cooling plate 3 and in not shown slots across the front terminal plate 6.

FIG. 4 shows a schematic representation of a further embodiment of the present invention.

In accordance with the FIG. 4 representation, a plurality of cells 2 are arranged between two respective retaining frames 16, 16 or 16, 17. The arrangement of cells 2 and retaining frames 16, 17 is disposed between two end plates 18, 19. Four tie rods 20 with locknuts 21 designed to guide a heat transfer medium are provided for clamping the assembly of cells, retaining frames 16, 17 and end plates 18, 19.

The end plates 18, 19 serve also as electrical terminals of the battery 1. Corresponding connection devices 23, 24 are provided for the connecting. A controller 26 affixed to a strut 25 is provided to monitor status parameters of the battery 1 and the individual cells 2 for charge equalization and the like. So as to prevent a short circuit between the end plates 18, 19, the tie rods 20 and/or locknuts 21 formed to guide a heat transfer medium are electrically insulated relative at least one of the end plates 18, 19.

In this present embodiment, the tie rods 20 formed to guide a heat transfer medium absorb the heat generated in the interior of the battery 1 which can be dissipated by the flow of the heat transfer medium.

They can moreover be in thermally conductive contact with the end plates 18, 19. The heat can also be dissipated via the end plates 18, 19 by means of a suitable cooling device (not further shown).

Conceivable as a cooling device is for example a profile of aluminum or a different good heat conductor around which air can circulate which is bolted to the end plates 18, 19 via the tie rod on the head end and/or the nut end. Alternatively, a heat exchanger can also be affixed on the end face of one of the end plates 18, 19 at which the tie rod 20 can dissipate heat. Other types of heat dissipation via the tie rod 20 are also conceivable.

Although not shown in any greater detail in the figure, the cells 2 in this embodiment are configured as so-called coffee bag or pouch cells. Such cells 2 comprise an electrode stack and a film-material housing (casing film) which is sealed at an edge section so as to form a so-called sealed seam. The connectors thereby enter through the sealed seam on two narrow sides of the cells 2. The retaining frames 16, 17 grip the cells 2 at the connectors themselves or in contact regions in the area of the sealed seam where the connectors enter through the sealed seam and at least there discharge heat to the frame elements 15, 17 via the connectors. The tie rods formed to guide a heat transfer medium run through the frame elements 16, 17 and absorb heat from the retaining frames 16, 17 in contact with the connectors. Alternatively, separate contact elements gripped by the retaining frames 16, 17 can be provided and exert the contact pressure on the edge sections of the cells 2 and absorb heat from same. Further alternatively, heat can be transferred from the flat sides of the cells 2 via heat conducting plates and/or heat conducting elastic elements arranged between the cells 2 to the retaining frames 16, 17 and from the latter in turn discharged via the tie rods 20.

In further embodiment variants, more than four tie rods, e.g. six or eight tie rods, can be provided to brace the cell block and dissipate heat.

Alternatively, the bracing can for example occur via heat conducting tension bands also in the case of a cell block formed in this manner. In a further embodiment variant, such tension bands can for example, but not restrictively, be led over chamfered edges 16.1, 17.1, 18.1, 19.1 of the retaining frame 16, 17 and the end plates 18, 19.

Furthermore, as depicted in FIG. 5, the tie rods 20 can be connected by means of a tie rod bridge 20.1, whereby a circulation of the heat transfer medium can be effected.

### LIST OF REFERENCE NUMERALS

1 battery
2 cell
3 cooling plate
3.1 coolant connection
3.2 slot
3.3 coolant channel
4 heat conducting film
5 pressure plate
5.1 slot
6 front terminal plate
7 rear terminal plate
6.1, 7.1 tab-like elongation
6.2, 7.2 fixing lug
7.3 slot
8 tension band
8.1 spring zone
8.2 tension band interstice
8.2′ interstice
8.20, 8.21, 8.22 heat conducting element
8.3 crimp seal
8.4 clamping range
16, 17 retaining frame
16.1, 17.1 chamfered edge
18, 19 end plates
18.1, 19.1 chamfered edge
20 tie rod
20.1 tie rod bridge
21 locknut
22, 23, 24 connection device
25 strut
26 controller

1-11. (canceled)

12. An energy storage apparatus comprising:
at least one energy storage cell;
a temperature control device configured to regulate the temperature of the energy storage cell; and
at least one clamping element having at least one tension band which is configured to contribute to spatially fixing the energy storage cells in the energy storage apparatus via tensioning force, wherein the tension band is configured as a functional component of the temperature control device and that the tension band is configured to conduct a heat transfer medium.

13. The energy storage apparatus according to claim 12, wherein the at least one energy storage cell comprises a plurality of energy storage cells and the temperature control device is configured to regulate the temperature of an assembly formed by the plurality of energy storage cells.

14. The energy storage apparatus according to claim 12, wherein the tension band comprises two longitudinal bores configured as a forward flow and a return flow channel.

15. The energy storage apparatus according to claim 12, wherein the clamping element comprises at least one pair of tension bands closed into a circuit via a tension band bridge.

16. The energy storage apparatus according to claim 12, wherein the clamping element is directly connected to a heat transfer medium circuit.

17. The energy storage apparatus according to claim 12, wherein the clamping element comprises at least one tie rod configured as a hollow bar.

18. The energy storage apparatus according to claim 17, wherein the at least one tie rod configured as a hollow bar leads to a heat exchanger.

19. The energy storage apparatus according to claim 12, wherein the clamping element comprises at least one pair of tie rods configured as hollow bars closed into a circuit via a tie rod bridge.

20. The energy storage apparatus according to claim 17, wherein the at least one tie rod configured as a hollow bar comprises two longitudinal bores configured respectively as a forward flow channel and a return flow channel.

21. The energy storage apparatus according to claim 12, wherein the clamping element is connected to a heat exchanger.

22. The energy storage apparatus according to claim 12, wherein the clamping element is at least partially formed from a heat conducting material and/or the clamping element at least partially comprises a heat conducting layer.
